(19) United States
(12) Patent Application Publication
(10) Pub. No.: US 2002/0155021 A1
(43) Pub. Date: Oct. 24, 2002

(54) Copper-alloy foil to be used for laminate sheet

(76) Inventors: Hifumi Nagai, Ibaraki (JP); Junji Miyake, Ibaraki (JP); Yasuo Tomioka, Ibaraki (JP)

Correspondence Address: BIRCH STEWART KOLASCH & BIRCH, PO BOX 747, FALLS CHURCH, VA, 22040-0747, US

(21) Appl. No.: 10/058,284

(22) Filed: Jan. 30, 2002

(30) Foreign Application Priority Data
Jan. 30, 2001 (JP) 2001-21986
Feb. 26, 2001 (JP) 2001-49857

(51) Int. Cl. C22C 9/00; B32B 15/08

(52) U.S. Cl. 420/492; 420/495; 428/458

(57) ABSTRACT

A copper alloy foil to be used in a printed board comprising a polyimide substrate is provided. The copper foil is not subjected to roughening plating and has hence fine surface roughness and can be directly bonded with the polyimide substrate. The copper alloy contains (a) one or more of the additive elements of from 0.01 to 2.0% of Cr and from 0.01 to 1.0% of Zr, or (b) from 1.0 to 4.8% of Ni and from 0.2 to 1.4% of Si. The surface roughness in terms of the ten-point average surface-roughness (Rz) is 2 μm or less, the 180° peeling strength is 8.0 N/cm or more. The alloy (a) has 600 N/mm² or more of tensile strength, and 50% ICAS or more of electric conductivity. The alloy (b) has 650 N/mm² or more of tensile strength, and 50% ICAS or more of electric conductivity.

### BACKGROUND OF INVENTION

1.Field of Invention

The present invention relates to a copper-alloy foil to be used for a laminate sheet of a printed circuit board.

2.Description of Related Art

The printed circuit board, which is frequently used for the electronic circuit of electronic devices, is roughly classified, depending upon the kind of base resin, into a rigid board comprising glass epoxy material or paper-phenol, and a flexible board comprising polyimide or polyester.

The flexible substrate is characterized by its flexibility. A flexible substrate is, therefore, used for the conductors of movable parts and can, thus, be mounted in the electronic devices in a bent state. The flexible board is, therefore space-saving material. In addition, since the flexible substrate is thin, it is used for the interposer of a semiconductor package or an IC tape carrier of a liquid-crystal display. A resin substrate and a copper foil are laminated with the aid of a binder, which is subsequently cured under heat and pressure, so as to produce a three-layer flexible substrate. Alternatively, a resin substrate and a copper foil may be directly laminated without a binder and are subjected to heat and pressure, so as to produce a two-layer substrate. A polyimide resin film and a polyester resin film are used for the resin substrate of the three-layer substrate. Epoxy resin and acrylic resin are frequently used for the binder. On the other hand, a polyimide resin is generally used for the substrate of the two-layer substrate. Lead-free solder, which is increasingly being used in the light of environmental protection, has a higher melting point than that of the conventional lead solder; accordingly, the requirement of heat resistance for the flexible substrate becomes severe.

A copper-laminate sheet of the printed circuit board is etched to delineate various conductor patterns. In assembling the electronic parts, they are soldered on the conductor patterns. Since the materials of the printed circuit board are repeatedly exposed to high temperature as explained above, they must be heat-resistant. Particularly in recent years, since the lead-free solder, which is being used in the light of environmental protection, has higher melting point than that of the conventional lead solder, higher heat resistance is required for the printed circuit board. Since only the polyimide resin, which has excellent heat resistance, is used as the organic material in the two-layer printed board, improvement of the heat resistance is easier in the case of the two-layer printed board than in the case of the three-layer printed board. Use amount of the former printed circuit board is, therefore, increasing.

Copper foil is mainly used as the conducting material of the printed circuit board. The copper foil is classified, depending upon the production process, into electro-deposited copper foil and wrought copper foil. The electro-deposited copper foil is produced by means of electrolytically precipitating copper from a copper sulfate bath on a titanium or stainless-steel drum.

The wrought copper foil is produced by means of plastically working the copper by rolling rolls. A characteristic of the wrought copper foil resides in that the surface profile of the rolling rolls is printed on the surface of a foil, so that the foil has a smooth surface.

A copper foil, which is used as the conductive material of a printed circuit board, must have good flexibility, and mainly wrought copper foil is used. In order to improve adherence of such copper foil with resin, the copper foil is subjected to roughening plating, that is, copper particles are electrolytically precipitated on the copper foil. Resin protrudes in the resultant unevenness on the copper foil and the mechanical bonding strength is thus provided. This is the so-called anchor effect to improve the adherence. It is tried in the three-layer flexible substrate that a silane coupling agent and the like are applied on a copper foil so as to improve the bonding strength of the metal, i.e., a copper foil, and the organic material, i.e., a binder. The bonding temperature of the two-layer flexible substrate is from 300 to 400° C. and is high as compared with that of the three-layer flexible substrate, that is, from 100 to 200° C. Thermal decomposition of the coupling agent is, therefore, likely to occur in the former substrate, thereby impairing its adherence. Incidentally, the foil is a sheet as thin as 100 μm or less.

Along with the recent trend towards size-reduction, weight-reduction and performance enhancement of electronic devices, high density mounting of a printed circuit board is demanded, particularly in such applications of the flexible substrate as a space-saving conductor, interposer of a semiconductor package, and an IC tape carrier of a liquid crystal display. Accordingly, the width of a conductor and the distance between the conductors of an electronic circuit is narrowed to realize a fine-pitch pattern. When a copper foil having large surface roughness or a roughening plated copper foil having an uneven surface is etched to delineate a circuit pattern, the resin may be left un-etched on the copper foil as etching residue. Alternatively, the etching linearity may be impaired, resulting in non-uniform circuit width. Therefore, fine surface roughness is advisable for the fine-pitch pattern of an electronic circuit. A copper foil, which is not subjected to the roughening plating, is desirably laminated with a resin film.

The frequency of signals of electronic devices, such as a personal computer and a device for mobile communication is being increasing. When the frequency of electronic signals becomes 1 GHz or higher, the skin effect, that is, when the current locally flows only on the surface of a conductor, becomes significant. When the current having frequency of 1 GHz or more is transmitted through the roughening-plated copper foil thus having a rough surface, such rough surface exerts significant influence upon the signal transmission. In order to avoid such influence, the required bonding strength should be ensured without the roughening treatment. Desirably, a copper foil without the roughening plating is laminated with a copper foil having fine surface roughness.

The conductive material used for the copper foil is pure copper or a copper alloy containing a small amount of an additive element. The copper foil becomes thin and narrow along with the trend for fine pitch of an electronic circuit as described above. Consequently, the electric conductivity of a copper foil must be high enough as to ensure small direct-current resistance-loss in a conductor. Since copper is a highly conductive material, pure copper having 99.9% or more of purity is usually used in applications where importance is attached to the electric conductivity as described above. However, the strength of copper is lowered with the increase in purity. Thin copper foil is difficult to handle. High strength is, therefore, desired for the copper foil.

Under the circumstances as described above, the present inventors carried out trials to produce a two-layer flexible substrate by using a copper foil made of oxygen-free copper having high purity and being appropriate for the conductive material. The rolled copper foil was not subjected to roughening plating and had fine surface roughness. The copper foil was bonded with a polyimide film without a binder. As a result, it turned out that the adherence of the polyimide film with the pure-copper foil was poor, and the film was liable to peel. The copper foil, which is not subjected to the roughening plating and has thus a fine surface roughness, is liable to peel when it is used in the two-layer flexible substrate. Such defects as disconnection of the conductors are liable to occur. The copper foil must, therefore, have high electric conductivity, high strength and such improved roughness as to achieve improved adherence with polyimide resin.

### SUMMARY OF INVENTION

The bonding strength required for a printed circuit board depends upon the production conditions of an electronic device and its using environment. It is alleged that 8.0 N/cm or more of 180° Peeling strength is practically acceptable.

It is therefore a target in the present invention to attain bonding strength in terms of 8.0 N/cm or more of 180° Peeling strength with regard to a copper foil, which has 2 μm or less of surface roughness Rz and which is not subjected to such special treatment as roughening plating. In terms of handling performance, the tensile strength before the heating for bonding is 600 N/mm² or more, preferably 650 N/mm² or more. A target value of the electric conductivity is 40% IACS or more, preferably 50% IACS or more.

It is an object of the present invention to provide a copper foil to be used in the laminate board, having fine surface roughness and improved adherence with polyimide.

The present inventors discovered that the adherence with polyimide is improved by means of adding a small amount of additive element(s) to pure copper, which has excellent electric conductivity. That is, pure copper is used as the base material and an alloy having improved adherence is provided. More specifically, the present inventors repeated research into the influence of additive element(s) on the adherence with polyimide, strength and electric conductivity and provide the following copper foils.

(1) A copper alloy foil, which contains, by mass percentage, one or more of the additive elements of from 0.01 to 2.0% of Cr and from 0.01 to 1.0% of Zr, the balance being essentially Cu and unavoidable impurities, and which has 600 N/mm² or more of tensile strength, 50% ICAS or more of electric conductivity, 2 μm or less of surface roughness in terms of the ten-point average surface-roughness (Rz) and 8.0 N/cm or more of 180° Peeling strength when directly bonded with a polyimide film without roughening plating.

(2) A copper alloy foil, which contains, by mass percentage, one or more of the first additive elements of from 0.01 to 2.0% of Cr and from 0.01 to 1.0% of Zr, and from 0.005 to 2.5% in total of one or more of the second additive elements selected from the group consisting of Ag, Al, Be, Co, Fe, Mg, Ni, P, Pb, Si, Sn, Ti and Zn, the balance being essentially Cu and unavoidable impurities, and which has 600 N/mm² or more of tensile strength, 50% ICAS or more of electric conductivity, 2 μm or less of surface roughness in terms of the ten-point average surface-roughness (Rz) and 8.0 N/cm or more of 180° Peeling strength when directly bonded with a polyimide film without roughening plating.

(3) A copper alloy foil, which contains, by mass percentage, one or more of the additive elements of from 1.0 to 4.8% of Ni and from 0.2 to 1.4% of Si, the balance being essentially Cu and unavoidable impurities, and which has 650 N/mm² or more of tensile strength, 50% ICAS or more of electric conductivity, 2 μm or less of surface roughness in terms of the ten-point average surface-roughness (Rz) and 8.0 N/cm or more of 180° Peeling strength when directly bonded with a polyimide film without roughening plating.

(4) A copper alloy foil, which contains, by mass percentage, one or more of the first additive elements of from 1.0 to 4.8% of Ni and from 0.2 to 1.4% of Si, and from 0.005 to 2.5% in total of one or more of the second additive elements selected from the group consisting of Ag, Al, Be, Co, Fe, Mg, P, Pb, Sn, Ti and Zn, the balance being essentially Cu and unavoidable impurities, and which has 650 N/mm² or more of tensile strength, 50% ICAS or more of electric conductivity, 2 μm or less of surface roughness in terms of the ten-point average surface-roughness (Rz) and 8.0 N/cm or more of 180° Peeling strength when directly bonded with a polyimide film without roughening plating.

### DESCRIPTION OF PREFERRED EMBODIMENTS

The alloy composition and the like are limited as described above in the present invention for the following reasons.

Cr, Zr: As is known, Cr and Zr have a catalytic effect to promote the polymerization of resin during its production. Cr and Zr added to a copper alloy foil enhance the adherence with the polyimide, probably because Cr and Zr are active elements and promote the bonding between the metal and the resin at the interface. When their additive amount is small, the catalytic effect is unsatisfactory such that the improvement in adherence is unsatisfactory. The Peeling strength should be of a level which is practically acceptable as a printed circuit board, i.e., 8.0 N/cm or more. In addition, since the handling performance of a thin copper foil is poor, high strength of copper foil is desired. Tensile strength of 600 N/mm² or more is necessary for enabling satisfactory handling of the copper foil during its bonding with a polyimide film. Cr and Zr have a strengthening effect and an effect to increase the bonding strength with polyimide. With the increase in the addition amount of Cr and Zr, the strength of copper alloy foil and the bonding strength with polyimide increase. One or more of Cr and Zr must be 0.01 mass % or more so as to attain the effects as described above.

On the other hand, with the increase in the addition amount of Cr and Zr coarse crystals may be formed due to segregation in the casting. Since metallic material including coarse crystals may be cracked during hot rolling, the hot workability of such material is poor. In addition, the direct-current resistance-loss should be low, and electric conductivity should be high, in a case where a copper foil is used in the electronic circuit with fine pitch-pattern. Namely, since the thickness and width of a copper foil are small in such electronic circuit, the electric conductivity must be sufficiently high as to prevent large direct-current resistance loss. With the increase in the addition amount of Cr and Zr, the electric conductivity may be lowered. The upper limit of addition amount of Cr, which does not incur the above-described drawbacks, is 2.0 mass %, preferably 0.4 mass %. The plastic working is easy at this Cr content. The upper limit of Zr is preferably 1.0 mass %, preferably 0.25 mass %. The plastic working is easy at this Zr content. Therefore, adequate alloy components of a copper-alloy foil to be used for the laminate printed circuit board is from 0.01 to 2.0% of Cr, more preferably from 0.01 to 0.4% of Cr, and from 0.01 to 1.0% of Zr, more preferably from 0.01 to 0.25% of Zr in terms of mass percentage.

Ni, Si: Ni used in the invention (3), above, has a catalytic effect of promoting the polymerization of resin during its production. Ni added to a copper alloy foil enhances the adherence with the polyimide probably, because Ni promotes the bonding between metal and resin at the interface. When their additive amount is small, the catalytic effect is unsatisfactory such that the improvement in adherence is slight. Ni content must be 1.0 mass % or more to attain the Peeling strength at a level of 8.0 N/cm or more, which is practically acceptable for a printed circuit board. In addition, Si forms with Ni the Ni₂Si precipitates and has a strengthening effect on copper and enhancing effect on electric conductivity. The desired strength due to the above effects is not obtained, when the Ni content is less than 1.0% and the Si content is less than 0.2%.

On the other hand, with the increase in the addition amount of Ni and Si in the invention (3) above, coarse crystals may be formed due to segregation in the casting. Since metallic material including coarse crystals may be cracked during hot rolling, the hot workability of such material is poor. In addition, coarse crystals may appear on the surface of material during cold rolling and form surface defects. Furthermore, when the addition amount of Ni and Si are large, the electric conductivity is drastically lowered so that the copper alloy is inappropriate as conductive material used in the circuit. The upper limit of addition amount of Ni and Si, which does not incur the above described drawbacks, is 4.8 mass % or less, preferably 3.0 mass % or less of Ni, and 1.4 mass % or less, preferably 1.0 mass % or less of Si. Plastic working is easy at these Ni and Si contents. Therefore, adequate alloy components of a copper-alloy foil to be used for the laminated printed circuit board is from 1.0 to 4.8%, preferably 1.0 to 3.0% of Ni and from 0.2 to 1.4%, preferably from 0.2 to 1.0% of Si, in terms of mass percentage.

Ag, Al, Be, Co, Fe, Mg, Ni, P, Pb, Si, Sn, Ti and Zn: Every one of Ag, Al, Be, Co, Fe, Mg, Ni (which is limited to the alloying element of the Cu-Cr/Zr alloy in this paragraph), P, Pb, Si (which is limited to the alloying element of Cu-Cr/Zr alloy in this paragraph), Sn, Ti and Zn is a strengthening element of copper. Its strengthening mechanism is mainly solid-solution strengthening. One or more of these elements is added, if necessary. When the total amount of one or more of these elements is 0.05 mass %, no desirable effects due to solid-solution strengthening are attained. On the other hand, when the total amount of one or more of these elements exceeds 2.5%, the electric conductivity, soldering property and workability are seriously impaired. The total amount of Ag, Al, Be, Co, Fe, Mg, Ni, P, Pb, Si, Sn, Ti and Zn is, therefore, from 0.005 to 2.5%.

Large surface roughness of a copper foil results in the skin effect such that the current of electric signal having 1 GHz or more of frequency locally flows only on the surface of a coil. As a result, the impedance increases and the transmission of high-frequency signals is seriously influenced. Fine surface roughness is, therefore, necessary for conductive material used in a high-frequency circuit. The present inventors examined the relationship between the surface roughness and the high-frequency performance and discovered that 2 μm or less of surface roughness in terms of the terms of the ten-point average surface-roughness (Rz) attains the desired high-frequency performance. The fine roughness can be provided by means of producing a wrought copper foil or electro-deposited copper foil under appropriate conditions, or chemically or electrolytically polishing the surface of a copper foil. Generally speaking, fine surface roughness is easily attained by a rolled copper foil, by means of decreasing the surface roughness of a work roll and hence printing on the copper alloy foil a fine profile of the work roll.

The production method of the copper alloy foil according to the present invention is not limited at all. For example, alloy plating may be carried out to produce an electro-deposited copper foil. The alloy may be melted, cast and rolled to produce a rolled copper foil. As an example, the rolling method is described hereinunder.

A predetermined amount of alloying element(s) is added to the molten pure copper, and the melt is cast into a mold to produce an ingot. Since such active elements as Cr, Zr and Si are added during the melting and casting process, this process is preferably carried out under vacuum or under protective gas atmosphere, so as to prevent the formation of oxide and the like. The ingot is hot-rolled to a certain thickness and scalped. Subsequently, the cold rolling and annealing are repeated. The final cold rolling is the final finishing step of a foil. Since the rolling oil adheres on the material as rolled, degreasing treatment is carried out with acetone or petroleum-based solvent.

An oxide layer, which may be formed in the annealing, impedes the following steps. The annealing should, therefore, be carried out under vacuum or in the inert gas atmosphere. Alternatively, the oxide layer may be removed. Preferably, pickling to remove the oxide layer is carried out with the use of sulfuric acid+hydrogen peroxide, nitric acid+hydrogen peroxide, or sulfuric acid+hydrogen peroxide+fluoride.

The present invention is hereinafter described with reference to the examples.

### EXAMPLES

The Cu-Cr/Zr alloy foil was produced by the following process.

Oxygen-free copper, which is the main raw material, is melted in a high-purity graphite crucible by using a high-frequency vacuum induction furnace, under Ar protective atmosphere. The auxiliary raw material is selected from copper-chromium mother alloy, copper-zirconium mother alloy, nickel, aluminum, silver, copper-beryllium mother alloy, cobalt, iron, magnesium, manganese, copper-phosphorus mother alloy, lead, tin, titanium, and zinc, in accordance with the additive element of the alloy. The auxiliary raw material is added to the main raw material upon its melting down. The alloy is cast into a mold made of iron. A copper-alloy ingot obtained by this method is approximately 2 kg in weight and has dimensions of 30 mm of thickness, 50 mm of width and 150 mm of length. This ingot is heated to 900° C. and is hot rolled to thickness of 8 mm. After removal of the oxide scale, the cold rolling and heat treatment are repeated to produce a 35 μm thick rolled copper alloy foil. Since the copper alloy containing Cr and Zr is a precipitation-hardening type alloy, solutionizing treatment is carried out, prior to the final cold rolling, by means of heating to a temperature in the range of from 600 to 900° C., followed by quenching in water and then heating to a temperature in the range of from 350 to 500° C. for 1 to 5 hours for precipitation of Cr and Zr. The strength and electric conductivity are increased by the precipitation.

The Cu-Ni-Si alloy foil was produced by the following process.

Oxygen-free copper, which is the main raw material, is melted in a high-purity graphite crucible by using a high-frequency vacuum induction furnace, under Ar protective atmosphere. The auxiliary raw material is selected from nickel, copper-silicon mother alloy, silver, aluminum, copper-beryllium mother alloy, cobalt, iron, magnesium, manganese, copper-phosphorus mother alloy, lead, tin, titanium, and zinc, in accordance with the additive element of the alloy. The auxiliary raw material is added to the main raw material upon its melting down. The alloy is cast into a mold made of iron. A copper-alloy ingot obtained by this method was approximately 2 kg in weight and has dimensions of 30 mm of thickness, 50 mm of width and 150 mm of length. This ingot is heated to 900° C. and is hot rolled to thickness of 8 mm. After removal of the oxide scales, the cold rolling and heat treatment are repeated to produce a 35 μm thick rolled copper alloy foil.

The 35 μm Cu-Cr/Zr or Cu-Ni-Si alloy foil is dipped in acetone to remove rolling oil adhered on it. The so-treated foil is dipped in aqueous solution which contains 10 mass % of sulfuric acid and 1 mass % of hydrogen peroxide so as to remove the oxide layer and the rust-proofing film. No special treatments for improving the adherence, such as immersion in aqueous solution, such as roughening plating and treatment with a silane coupling agent, are carried out. The so-treated copper foil is laminated and bonded with a polyimide film by means of a flat-plane heating press under the following conditions. The copper foil and the polyimide foil were pre-heated for 5 minutes in a flat-plane heating machine maintained at a temperature of 330° C., and then subjected to 490 N/cm² of pressure for 5 minutes, followed by unloading and then cooling.

The kind of polyimide film is pyromellitic acid-based, biphenyltetracarboxylic acid-based, benzophenone tetracarboxylic acid-based and the like. The polyimde film used as the flexible substrate is from 10 to 60 μm thick in many cases. A polyimide film is from 10 to 30 μm thick. The polyimide film used in the present example is biphenyltetracarboxylic acid based having the structural formula given below and is 25 μm thick.

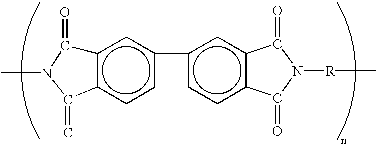

With regard to the Cu-Cr/Zr-based and Cu-Ni-Si-based copper-alloy foils obtained as described above, “the hot-rolling workability”, “the surface defects” (with regard to only the Cu-Ni-Si-based alloy), “the surface roughness”, “the electrical conductivity”, “high-frequency performance”, “tensile strength”, and “bonding strength” after bonding with the polyimide film were evaluated by the following methods.

(1) Hot-rolling Workability. The hot-rolled material is examined by liquid penetrant testing. Appearance of the material is observed by the naked eye to detect the presence or absence of cracks. The absence of cracks is indicated by ◯, while the presence of cracks is indicated by ×. The evaluations of cracked material after the hot-rolling could not be subjected.

(2) Surface Defects (only with regard to the Cu-Ni-Si based copper alloy foil). A 10 m long sample was taken from the rolled foil and is subjected to the surface observation by the naked eye. The number of defects is counted. Less than five defects is indicated by ◯, and five or more samples by ×.

(3) Surface Roughness. A probe-type surface-roughness tester was used to measure the surface roughness in a direction perpendicular to the rolling direction under the condition stipulated in JIS B 0601. The ten-point average surface roughness is evaluated.

(4) Electrical conductivity. The electric resistance at 20° C. is measured by the direct current four-terminal method, in which double bridges are used. The measured specimens are a 35 μm thick foil cut into 12.7 mm width. The distance for measuring the electric resistance is 50 mm.

(5) High Frequency Performance: The high-frequency impedance was measured by conducting high-frequency current of 10 MHz and 20 mA through a 35 μm thick copper foil cut into 1 mm width. The distance for measuring the electric resistance is 100 mm. Voltage drop in this distance is measured.

(6) Tensile Strength. The tensile strength at room temperature is measured by a tensile method. A 35 μm thick wrought copper foil is cut by means of a precision cutter into a strip form 12.7 mm in width and 150 mm in length to prepare a tensile specimen. The gauge length is 50 mm. The tensile speed is 50 mm/minute.

(7) Peeling strength. 180° peeling strength is measured in accordance with the method stipulated in JIS C 5016. Since the strength of copper-alloy foils varies depending upon their composition, each copper-alloy foil is adhered on the tensile-strength tester with double sided adhesive tape, and a polyimide film is bent into the 180° direction and peeled from the copper foil. The peeling width is 5.0 mm. The tensile speed is 50 mm/minute

The composition of Cu-Cr/Zr alloy foils is shown in Table 1. The evaluation results of the properties of these foils are shown in Table 2. Since a large amount of volatile matter generated during the oxygen analysis of the copper alloy foils containing Zr or Pb, their oxygen content cannot be measured. Sample Nos. 1 through 13 are the copper alloy foils according to the inventive examples. As is shown in Table 2, in the case of the copper alloy foils according to the inventive examples, the electric conductivity is 50% IACS or more, the tensile strength is 600 N/mm² or more, and the 180° Peeling strength of a foil bonded with polyimide is 8.0 N/cm or more. This indicates excellent electric conductivity and handling performance, as well as high bonding strength. In addition, no cracks generated during the hot rolling.

On the other hand, the alloying elements according to the present invention are not added to Comparative Sample No. 14 shown in Table 1. Namely, oxygen-free copper is melted and cast into an ingot under the Ar protective atmosphere. The ingot is worked into a foil, which is then bonded with polyimide. Since the material is pure copper, the electric conductivity is high. However, 180° Peeling strength is 7.0 N/cm, and hence, the bonding strength is unsatisfactory. When such foil is laminated in a printed circuit board, there is a danger of peeling.

Only either Cr or Zr is added in Comparative Samples Nos. 15 and 16. Their foil working method is the same as the inventive method. Since the Cr and Zr concentration is less than 0.01 mass %, the adherence is not satisfactorily improved. The 180 ° Peeling strength is less than 8.0 N/cm.

Cr added in Comparative Sample No. 17 exceeds the concentration of 2.0 mass % and forms coarse Cr crystals during the casting. Cracks generated during the hot rolling. The hot workability is, therefore, poor. Since Zr added in Comparative Sample No. 18 exceeds the concentration of 1.0 mass %, cracks generated as well during the hot rolling. Comparative Samples Nos. 17 and 18 are, therefore, not subjected to the subsequent process.

Ti added in Comparative Sample No. 19 exceeds the concentration of 2.5 mass %. The electric conductivity of this sample is low and is inappropriate as the conductive material of a printed circuit board.

Comparative Samples Nos. 20 and 21 are the alloy foils of Sample No. 6, which are lightly polished with Emery paper to roughen the surface. Since the surface is rough, the impedance is high when high-frequency current is conducted through the sample due to the skin effect. These comparative samples are, therefore, inappropriate as the conducting material.

TABLE 1

| | | Chemical Components | | | | | | | | | | | | | | | | |
|---|---|---|---|---|---|---|---|---|---|---|---|---|---|---|---|---|---|---|
| | | | | | | | | | | | | | | | | | | Cu and un- |
| | | (%) | | | | | | | | | | | | | | | (ppm) | avoidable |
| | No. | Cr | Zr | Ag | Al | Be | Co | Fe | Mg | Ni | P | Pb | Si | Sn | Ti | Zn | ◯ | impurities |
| Inventive | 1 | 0.17 | — | — | — | — | — | — | — | — | — | — | — | — | — | — | 5 | bal |
| | 2 | 1.5 | — | — | — | — | — | — | — | — | — | — | — | — | — | — | 8 | bal |
| | 3 | — | 0.18 | — | — | — | — | — | — | — | — | — | — | — | — | — | 4 | bal |
| | 4 | — | 0.47 | — | — | — | — | — | — | — | — | — | — | — | — | — | 10 | bal |
| | 5 | 0.47 | 0.46 | — | — | — | — | — | — | — | — | — | — | — | — | — | 4 | bal |
| | 6 | 0.19 | 0.09 | — | — | — | — | — | — | — | — | — | — | — | — | 0.21 | — | bal |
| | 7 | 0.38 | 0.17 | — | — | — | — | — | — | — | — | — | — | — | — | 0.11 | — | bal |
| | 8 | 0.32 | — | — | — | — | — | — | — | 0.72 | — | — | — | 0.71 | 0.50 | — | 3 | bal |
| | 9 | 0.76 | 0.15 | — | — | — | — | — | 0.05 | — | — | — | — | — | — | — | 8 | bal |
| | 10 | 0.96 | — | — | — | — | — | 0.10 | — | — | — | 0.06 | 0.11 | — | — | — | — | bal |
| | 11 | 0.71 | — | 0.11 | — | — | — | — | — | — | 0.04 | 0.15 | — | — | — | — | — | bal |
| | 12 | 0.18 | — | — | 0.01 | — | 0.60 | 1.4 | — | — | — | 0.01 | — | 0.45 | — | — | — | bal |
| | 13 | — | 0.18 | — | — | 0.22 | 0.61 | — | — | 1.2 | — | — | — | — | — | — | 7 | bal |
| Compar- | 14 | — | — | — | — | — | — | — | — | — | — | — | — | — | — | — | 4 | bal |
| ative | 15 | 0.007 | — | — | — | — | — | — | — | — | — | — | — | — | — | — | 4 | bal |
| | 16 | — | 0.004 | — | — | — | — | — | — | — | — | — | — | — | — | — | 4 | bal |
| | 17 | 2.4 | — | — | — | — | — | — | — | — | — | — | — | — | — | — | 6 | bal |
| | 18 | — | 1.4 | — | — | — | — | — | — | — | — | — | — | — | — | — | 10 | bal |
| | 19 | 0.28 | — | — | — | — | — | — | — | — | — | — | — | — | 2.7 | — | 5 | bal |
| | 20 | 0.19 | 0.09 | — | — | — | — | — | — | — | — | — | — | — | — | 0.21 | — | bal |
| | 21 | 0.19 | 0.09 | — | — | — | — | — | — | — | — | — | — | — | — | 0.21 | — | bal |

TABLE 2

| | | | Surface | Electric | | | |
|---|---|---|---|---|---|---|---|
| | | | Roughness | Con- | | Tensile | 180° Peel |
| | | Hot Rolling | (Rz) | ductivity | Impedance | Strength | Strength |
| | No. | Workability | (μm) | (% IACS) | (Ω) | (N/mm²) | (N/cm) |
| Inventive | 1 | ◯ | 1.2 | 85 | 2.13 | 630 | 8.1 |
| | 2 | ◯ | 1.0 | 69 | 2.03 | 780 | 9.2 |
| | 3 | ◯ | 1.3 | 90 | 2.55 | 610 | 8.5 |
| | 4 | ◯ | 1.3 | 75 | 2.89 | 640 | 8.6 |
| | 5 | ◯ | 1.0 | 83 | 2.11 | 650 | 10.2 |
| | 6 | ◯ | 0.9 | 70 | 1.98 | 720 | 9.0 |
| | 7 | ◯ | 1.0 | 84 | 2.19 | 730 | 8.6 |
| | 8 | ◯ | 1.0 | 55 | 2.30 | 820 | 8.2 |
| | 9 | ◯ | 0.9 | 82 | 1.87 | 660 | 10.1 |
| | 10 | ◯ | 1.3 | 80 | 2.52 | 700 | 9.1 |
| | 11 | ◯ | 1.1 | 66 | 2.40 | 720 | 8.5 |
| | 12 | ◯ | 1.0 | 52 | 2.51 | 690 | 8.4 |
| | 13 | ◯ | 0.9 | 55 | 2.02 | 810 | 8.2 |
| Comparative | 14 | ◯ | 1.4 | 99 | 2.61 | 400 | 7.0 |
| | 15 | ◯ | 1.4 | 93 | 2.73 | 480 | 7.4 |
| | 16 | ◯ | 1.3 | 97 | 2.51 | 520 | 7.2 |
| | 17 | X | — | — | — | — | — |
| | 18 | X | — | — | — | — | — |
| | 19 | ◯ | 0.8 | 11 | 2.42 | 950 | 8.4 |
| | 20 | ◯ | 2.4 | 70 | 5.13 | 720 | 9.5 |
| | 21 | ◯ | 3.8 | 70 | 7.36 | 720 | 9.6 |

On the other hand, the alloying elements according to the present invention are not added to Comparative Sample No. 32 shown in Table 3. Namely, oxygen-free copper is melted and cast into an ingot under Ar protective atmosphere. The ingot is worked into a foil, which is then bonded with polyimide. Since the material is pure copper, the electric conductivity is high. However, 180° Peeling strength is 7.0 N/cm, hence the bonding strength is unsatisfactory. When such foil is laminated in a printed circuit board, there is a danger of peeling. Since the tensile strength is less than 400 N/mm², the handling performance is poor.

Ni and Si are added in Comparative Samples Nos. 33 and 34. Their foil working method is the same as the inventive method. Since the Si concentration of Comparative Sample No. 33 is less than 0.2 mass %, the electric conductivity is less than 40% IACS. Since the Ni concentration of Comparative Sample No. 34 is less than 1.0%, the adherence is not satisfactorily improved. The 180° Peeling strength is as low less than 8.0 N/cm.

Ni and Si are added in Comparative Sample No. 35. Since Ni exceeds the concentration of 4.8 mass % and forms coarse crystals and a number of surface defects. The electric conductivity is low. Ni and Si are added in Comparative Sample No. 36. Since Si exceeds the concentration of 1.4 mass %, cracks generated during the hot rolling. Comparative Sample No. 36 is, therefore, not subjected to the subsequent process.

Fe added in Comparative Sample No. 37 exceeds the concentration of 2.5 mass %. The electric conductivity of this sample is low and is inappropriate as the conductive material of a printed circuit board.

Comparative Samples Nos. 38 and 39 are the alloy foils of Sample No. 24, which are lightly polished with Emery paper to roughen the surface. Since the surface is rough, impedance is high when high-frequency current is conducted through the sample due to the skin effect. These comparative samples are, therefore inappropriate as the fine pich conductors.

TABLE 3

| | | Chemical Components | | | | | | | | | | | | | |
|---|---|---|---|---|---|---|---|---|---|---|---|---|---|---|---|
| | | | | | | | | | | | | | | | Cu and Un- |
| | | % | | | | | | | | | | | | | avoidable |
| No. | | Ni | Si | Ag | Al | Be | Co | Fe | Mg | P | Pb | Sn | Ti | Zn | Impurities |
| Inventive | 22 | 1.4 | 0.33 | — | — | — | — | — | — | — | — | — | — | — | bal |
| | 23 | 2.5 | 0.52 | — | — | — | — | — | — | — | — | — | — | — | bal |
| | 24 | 3.1 | 0.62 | — | — | — | — | — | — | — | — | — | — | — | bal |
| | 25 | 2.5 | 0.74 | 0.09 | — | — | — | — | — | — | — | — | — | 0.24 | bal |
| | 26 | 2.4 | 0.64 | — | — | — | — | — | 0.15 | — | — | — | 0.30 | — | bal |
| | 27 | 3.1 | 0.39 | — | — | — | — | 0.30 | — | — | — | 0.58 | — | — | bal |
| | 28 | 2.8 | 0.37 | — | 0.55 | — | — | — | — | — | 0.06 | — | — | — | bal |
| | 29 | 3.2 | 0.71 | — | — | — | — | — | — | 0.04 | — | — | — | 0.10 | bal |
| | 30 | 1.7 | 0.54 | — | — | — | — | — | 0.05 | — | — | — | 0.54 | — | bal |
| | 31 | 2.6 | 0.48 | — | — | 0.11 | 0.60 | — | — | — | — | — | — | — | bal |
| Comparative | 32 | — | — | — | — | — | — | — | — | — | — | — | — | — | bal |
| | 33 | 3.5 | 0.04 | — | — | — | — | — | — | — | — | — | — | — | bal |
| | 34 | 0.65 | 0.22 | — | — | — | — | — | — | — | — | — | — | — | bal |
| | 35 | 5.2 | 0.39 | — | — | — | — | — | — | — | — | — | — | — | bal |
| | 36 | 3.2 | 1.9 | — | — | — | — | — | — | — | — | — | — | — | bal |
| | 37 | 2.8 | 0.80 | — | — | — | — | 2.9 | — | — | — | — | — | — | bal |
| | 38 | 3.1 | 0.62 | — | — | — | — | — | — | — | — | — | — | — | bal |
| | 39 | 3.1 | 0.62 | — | — | — | — | — | — | — | — | — | — | — | bal |

TABLE 4

| | | Hot | | Surface | Electric | | | |
|---|---|---|---|---|---|---|---|---|
| | | Rolling | | Roughness | Con- | | Tensile | 180° Peel |
| | | Work- | Surface | (Rz) | Ductivity | Impedance | Strength | Strength |
| | No. | ability | Defects | (μm) | (% IACS) | (Ω) | (N/mm²) | (N/cm) |
| Inventive | 22 | ◯ | ◯ | 0.9 | 64 | 2.43 | 660 | 8.1 |
| | 23 | ◯ | ◯ | 0.7 | 52 | 2.58 | 750 | 8.7 |
| | 24 | ◯ | ◯ | 0.7 | 48 | 2.90 | 800 | 9.5 |
| | 25 | ◯ | ◯ | 1.1 | 51 | 2.47 | 790 | 8.2 |
| | 26 | ◯ | ◯ | 0.8 | 48 | 2.61 | 650 | 10.1 |
| | 27 | ◯ | ◯ | 0.8 | 42 | 2.98 | 720 | 9.8 |
| | 28 | ◯ | ◯ | 0.7 | 41 | 2.70 | 730 | 8.2 |
| | 29 | ◯ | ◯ | 0.6 | 62 | 2.87 | 820 | 8.3 |
| | 30 | ◯ | ◯ | 0.8 | 56 | 2.71 | 660 | 9.1 |
| | 31 | ◯ | ◯ | 0.7 | 50 | 2.71 | 810 | 9.2 |
| Compartive | 32 | ◯ | ◯ | 1.4 | 99 | 2.61 | 400 | 7.0 |
| | 33 | ◯ | ◯ | 1.0 | 37 | 2.59 | 610 | 9.3 |
| | 34 | ◯ | ◯ | 1.0 | 68 | 2.29 | 640 | 7.0 |
| | 35 | ◯ | X | 1.9 | 38 | 3.20 | 800 | 8.7 |
| | 36 | X | — | — | — | — | — | — |
| | 37 | ◯ | ◯ | 1.4 | 23 | 2.85 | 780 | 9.4 |
| | 38 | ◯ | ◯ | 2.7 | 48 | 5.51 | 800 | 9.6 |
| | 39 | ◯ | ◯ | 3.6 | 48 | 6.90 | 800 | 9.8 |

1. A copper alloy foil, which contains, by mass percentage, one or more of the additive elements of from 0.01 to 2.0% of Cr and from 0.01 to 1.0% of Zr, the balance being essentially Cu and unavoidable impurities, and which has 600 N/mm² or more of tensile strength, 50% ICAS or more of electric conductivity, 2 μm or less of the surface roughness in terms of the ten-point average surface-roughness (Rz) and 8.0 N/cm or more of 180° peel strength when directly bonded with a polyimide film without roughening plating.

2. A copper alloy foil according to claim 1, wherein it further contains from 0.005 to 2.5% in total of one or more of the second additive elements selected from the group consisting of Ag, Al, Be, Co, Fe, Mg, Ni, P, Pb, Si, Sn, Ti and Zn,

3. A copper alloy foil, which contains, by mass percentage, one or more of the additive elements of from 1.0 to 4.8% of Ni and from 0.2 to 1.4% of Si, the balance being essentially Cu and unavoidable impurities, and which has 650 N/mm² or more of tensile strength, 50% ICAS or more of electric conductivity, 2 μm or less of the surface roughness in terms of the ten-point average surface-roughness (Rz) and 8.0 N/cm or more of 180° peel strength when directly bonded with a polyimide film without roughening plating.

4. A copper alloy foil according to claim 3, wherein it further contains from 0.005 to 2.5% in total of one or more of the second additive elements selected from the group consisting of Ag, Al, Be, Co, Fe, Mg, P, Pb, Sn, Ti and Zn.

5. A printed circuit board which comprises: a copper alloy foil, which contains, by mass percentage, one or more of the additive elements of from 0.01 to 2.0% of Cr and from 0.01 to 1.0% of Zr, the balance being essentially Cu and unavoidable impurities, and which has 600 N/mm² or more of tensile strength, 50% ICAS or more of electric conductivity, 2 μm or less of the surface roughness in terms of the ten-point average surface-roughness (Rz), and which is not subjected roughening plating; and, a polyimide film, which is directly bonded with the copper alloy foil and which has 8.0 N/cm or more of 180° peel strength.

6. A printed circuit board according to claim 5, wherein the copper alloy foil further contains from 0.005 to 2.5% in total of one or more of the second additive elements selected from the group consisting of Ag, Al, Be, Co, Fe, Mg, Ni, P, Pb, Si, Sn, Ti and Zn,

7. A printed circuit board, comprising a copper alloy foil, which contains, by mass percentage, one or more of the additive elements of from 1.0 to 4.8% of Ni and from 0.2 to 1.4% of Si, the balance being essentially Cu and unavoidable impurities, and which has 650 N/mm² or more of tensile strength, 50 % ICAS or more of electric conductivity, 2 μm or less of the surface roughness in terms of the ten-point average surface-roughness (Rz), and which is not subjected to roughening plating; and, a polyimide film, which is directly bonded with the copper alloy foil and has 8.0 N/cm or more of 180° peel strength.

8. A printed circuit board according to claim 7, wherein it further contains from 0.005 to 2.5% in total of one or more of the second additive elements selected from the group consisting of Ag, Al, Be, Co, Fe, Mg, P, Pb, Sn, Ti and Zn.
